(19) United States
(12) Patent Application Publication
(10) Pub. No.: US 2010/0240144 A1
(43) Pub. Date: Sep. 23, 2010

(54) IMPROVED SERRS SUBSTRATE

(75) Inventor: Richard Gilbert, Essex (GB)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: E2V BIOSENSORS LIMITED, Essex (GB)

(21) Appl. No.: 12/294,875

(22) PCT Filed: Mar. 27, 2007
(86) PCT No.: PCT/GB07/01071

§ 371 Date: Nov. 4, 2009

(30) Foreign Application Priority Data
Mar. 27, 2006 (GB) 0606088.3

(51) Int. Cl. G01N 21/78

(52) U.S. Cl. 436/169; 422/69

(57) ABSTRACT

An improved SERRS substrate for use in an improved analyte detector is provided by depositing a Raman enhancing surface on, or within, a porous 3D support matrix made of a solid support material. The support material is arranged to have a Raman dye distributed within the volume and the response to illumination of the dye is enhanced as a result of the dye being distributed within the volume and proximate to the Raman enhancing surface, which is also distributed within the volume.

### FIELD OF THE INVENTION

The present invention relates to Raman spectroscopy, surface enhanced Raman spectroscopy and surface enhanced resonance Raman spectroscopy.

### BACKGROUND OF THE INVENTION

It is known that there are many techniques to detect the action or presence of analyte molecules. One such technique utilises the Raman Scattering (RS) effect. When light is scattered from a molecule, most of the photons are elastically scattered. The majority of the scattered photons have the same energy (and therefore frequency and wavelength) as the incident photons. However, a small fraction of the light (approximately 1 in 10⁷ photons) is scattered at frequencies different from that of the incident photons. When the scattered photon loses energy to the molecule, it has a longer wavelength than the incident photon (termed Stokes scatter). Conversely, when a scattered photon gains energy, it has a shorter wavelength (termed anti-Stokes scatter). Stokes scatter is usually the stronger effect.

The process leading to this inelastic scatter is termed the Raman effect after Sir C. V. Raman, who first described it in 1928. It is associated with a change in the vibrational, rotational or electronic energy of the molecule, with the energy transferred from the photon to the molecule usually being dissipated as heat. The energy difference between the incident photon and the Raman scattered photon is equal to the energy of a vibrational state or electronic transition of the scattering molecule, giving rise to scattered photons at quantised energy differences from the incident laser. A plot of the intensity of the scattered light versus the energy or wavelength difference is termed the Raman spectrum, and the technique is known as Raman spectroscopy (RS).

Surface enhanced Raman spectroscopy (SERS) is a variant of the RS analytical technique. The strength of the Raman signal can be increased enormously if the molecules are physically close to certain metal surfaces, due to an additional energy transfer between the molecule and the surface electrons (plasmons) of the metal. To perform SERS, the analyte molecules are adsorbed onto a substrate comprising an atomically roughened metal surface and the enhanced Raman scattering is detected. SERS can also be performed using silver colloids in solution as the substrate.

The Raman scattering from a molecule or ion within a few Angstroms of a metal surface can be 10³ to 10⁶ fold greater than in solution. For near visible wavelengths, SERS is strongest on silver, but is readily observable on gold and copper as well. Recent studies have shown that a variety of other transition metals may also give useful SERS enhancements. So-called free electron metals, that is metals having a high number of free surface electrons, generally provide SERS enhancements. Furthermore, so-called metallic polymers could also be used; these being organic polymers that have an electronic structure such that they behave in a similar manner to a metal. It will be appreciated that the term metal is not limited to a metallic element or a mixture or alloy of metals and can apply to any material that the skilled person would understand to be a metal. Materials that provide such SERS enhancements are henceforth referred to as Raman enhancing surfaces or metals.

The SERS effect is in essence a resonance energy transfer between the molecule and an electromagnetic field near the surface of the metal. The electric vector of the excitation laser induces a dipole in the surface of the metal, and the restoring forces result in an oscillating electromagnetic field at a resonant frequency of this excitation. The strength and frequency of this resonance is determined mainly by the free electrons at the surface of the metal (the ‘plasmons’) determining the so-called plasmon wavelength, as well as by the dielectric constants of the metal and its environment. Molecules adsorbed on or in close proximity to the surface experience an exceptionally large electromagnetic field in which coupling to vibrational modes normal to the surface are most strongly enhanced. This is the surface plasmon resonance (SPR) effect, which enables a through-space energy transfer between the plasmons and the molecules near the surface. The intensity of the surface plasmon resonance is dependent on many factors including the wavelength of the incident light and the morphology of the metal surface, since the efficiency of energy transfer relies on a good match between the laser wavelength and the plasma wavelength of the metal.

The strength and local density of the field is determined by a variety of parameters. The wavelength of the reflected light determines its energy, and the composition and morphology of the metal determines the strength and efficiency with which the surface plasmons couple to the photon energy. Other factors, such as the relative dielectric properties of the metal and analyte solution, also have strong contributions to the effect. In addition, the efficiency of energy transfer between the field and any molecules close to the metal surface is also determined by resonant energetic states in the molecule itself, including, for example, specific vibrational modes in the infrared spectral region and electronic energy transitions in the ultraviolet. This is the mechanism by which SERRS gains performance over conventional SERS. SERRS can be performed by using a chromophore moiety to provide an additional molecular resonance contribution to the energy transfer.

The intensity of a resonance Raman peak is proportional to the square of the scattering cross section of the molecule. The scattering cross section is, in turn, related to the square of the transition dipole moment, and therefore usually follows the absorption spectrum. If the incident photons have energies close to an absorption peak in their absorbance spectrum, then the molecules are more likely to be in an excited state when the scattering event occurs, thereby increasing the relative strength of the anti-Stokes signal. A combination of the surface and resonance enhancement effects means that SERRS can provide a huge signal enhancement, typically of 10⁹ to 10¹⁴ fold over conventional Raman spectroscopy.

In addition to resonance enhancement for Raman scattering, there have recently been descriptions of resonance de-enhancement, in which the Raman signal is reduced in intensity by a resonance energy transfer mechanism. Under specific conditions, an excited energy state close in energy to that of interest can produce a decrease in Raman scattering. In this situation, the Raman intensity is proportional to the square of the sum of the cross sections, and if they are of opposite signs then destructive interference can occur, resulting in the observed resonance de-enhancement. This provides an alternative metric for use in a Raman-based detector system: signals from a particular Raman-active chromophore may be selectively removed from the Raman spectrum by using a laser frequency that promotes this de-enhancement effect.

Surface enhanced Raman spectroscopy (SERS) and its extension, surface enhanced resonance Raman spectroscopy (SERRS) are gaining in popularity as quantitative bioanalytical tools. Both techniques rely to a large degree on an interaction between the ‘plasma’ of mobile conduction electrons at the surface of a metal (the plasmons) and molecular species close to that surface. This interaction results in a substantial enhancement of Raman scattering at specific vibrational energies, yielding a strong spectral signal in the Raman scattered light.

Until recently, a controversy surrounded the understanding of the enhancement mechanisms. The two major factions disagreed on the partitioning of the greater than 10⁶ enhancement factor between the chemical enhancement mechanism and the electromagnetic enhancement mechanism. The chemical enhancement mechanism, now thought to contribute an enhancement factor of 10², asserts that a charge-transfer state is created between the metal and adsorbate molecules. This mechanism is site-specific and analyte dependent. The molecule must be directly adsorbed to the surface in order to experience the chemical enhancement. The electromagnetic enhancement mechanism contributes a greater than 10⁴ times enhancement over normal Raman scattering. In order to understand the electromagnetic enhancement, one must consider the size, shape, and material of the surface's nanoscale roughness features. If the correct wavelength of light strikes a metallic roughness feature, the plasma of conduction electrons will oscillate collectively. Because this collective oscillation is localized at the surface of this plasma of electrons, it is known as a localized surface plasmon resonance (LSPR). The LSPR allows the resonant wavelength to be absorbed and scattered, creating large electromagnetic fields around the roughness feature. If a molecule is placed within the electromagnetic fields, an enhanced Raman signal is measured.

We have appreciated the problem that the Raman scattering effect, even using surface enhanced Raman scattering (SERS), provides a small amount of Raman scattered radiation in comparison to normal scattering (effectively a poor signal to noise ratio). We have further appreciated that, because the Raman signal is weak in comparison to noise, there is a need to introduce a mechanism to help distinguish the Raman signal from the noise.

We have appreciated that reducing diffusion path lengths of analyte molecules can have a dramatic impact on the speed of the biosensor assay. Accordingly, in broad terms, the invention provides an arrangement that reduces the diffusion path lengths of a sample to be tested using spectroscopic techniques.

### SUMMARY OF THE INVENTION

The invention is defined in the claims to which reference is directed.

An embodiment of the invention provides an improved analyte detector with a Raman enhancing volume located within the reaction region created by depositing a Raman enhancing surface on, or within, a porous 3D support matrix made of a solid support material. The support material is arranged to have a dye distributed within the volume and the response to illumination of the dye is enhanced as a result of the dye being distributed within the volume and proximate to the Raman enhancing surface that is also distributed within the volume.

A reaction carrier for use in an analyte detector, into which a sample for testing is introduced, may be produced according to the invention having a solid support material arranged to define a volume and a metal/Raman enhancing surface distributed and immobilised within the volume. The metal is supported by the support material, which is being porous to a dye that allows the analyte to be detected. The metal is arranged such as to enhance an optical response to illumination of the dye.

Whilst the embodiment(s) of the invention described refer to the improvements provided to the Raman signal and its applications in Raman spectroscopy (particularly SERS and SERRS), it should be appreciated that the invention may be used in any form of spectroscopy in which an improvement in the signal strength can be obtained by using a metal surface being such as to enhance a response to illumination of a dye. This may, for example, include surface absorption fluorescence or any response to illumination that involves a resonant energy transfer to the metal surface.

The term chromophore is well known to the skilled person and is used herein to cover a group having specific optical characteristics. The term “dye” refers to a chromophore that can emit Raman radiation and also has some sort of functionality such as a linking group or a surface-seeking group. Such functionalities could result, for example, from adding a metal surface seeking group, or a group to allow binding to an analyte. The chromophore should strongly absorb the excitation laser at wavelengths suitable for surface enhancement (the most popular Raman lasers are 514 nm, 532 nm, and 785 nm). This is in the green-red visible range, so traditional brightly coloured chromophores are found as a constituent of particularly good Raman-active dyes.

An analyte is any chemical that it is desired to detect or quantify. Examples of suitable analytes include: biological molecules (such as proteins, antibodies, nucleic acids, carbohydrates, proteoglycans, lipids, or hormones), pharmaceuticals or other therapeutic agents and their metabolites, drugs of abuse (for example amphetamines, opiates, benzodiazepines, barbiturates, cannabinoids, cocaine, LSD and their metabolites), explosives (for example nitro-glycerine and nitrotoluenes including TNT, RDX, PETN and HMX), and environmental pollutants (for example herbicides, pesticides).

An analyte sample is any sample that it is desired to test for the presence, or amount, of analyte. There are many situations in which it is desired to test for the presence, absence, or amount, of an analyte. Examples include clinical applications (for example to detect the presence of an antigen or an antibody in a biological sample such as a blood or urine sample), to detect the presence of a drug of abuse (for example in an illicit sample, or a biological sample such as a body fluid or breath sample), to detect explosives, or to detect environmental pollutants (for example in a liquid, air, soil, or plant sample).

In addition to directly detecting analytes themselves, it is also possible to detect them indirectly by using a reporter molecule which is able to generate a detectable change in its Raman signal in the presence of the analyte of interest. An example of this would be the displacement of a dye-labelled peptide from the antigen binding site of an analyte-specific antibody, thereby releasing free reporter molecules which are then able to interact with the SERRS-active metal surface. For our purposes, such reporter molecules can also be regarded as ‘analytes’.

Typically a reporter molecule will comprise a reporter dye, a selective agent binding group, and a metal surface-binding group. The reporter molecule is bound to the selective agent (by means of the selective agent binding group), and the reporter dye is therefore held away from the metal surface, before the analyte sample is introduced to the carrier. Binding of the analyte to the selective agent displaces the reporter molecule, which then binds to the metal surface (by means of the metal surface binding group) thereby causing the reporter dye to move to the region near the metal surface. The term “dye” as referred to above applies equally to a reporter molecule.

A selective agent is any agent that binds selectively to the analyte in the presence of the other components of the analyte sample, and under the conditions in which the detection method is carried out, so that the presence (or amount) of the analyte in the sample can be detected. The nature of the selective agent will of course depend on the identity of the analyte. In many cases, the selective agent will be an antibody. However, other suitable analyte binding partners may be used. For example, if the analyte is an antibody, the selective agent may be an antigen or antigen derivative that is selectively bound by the antibody. If the analyte is nucleic acid, the selective agent may be a nucleic acid, or a nucleic acid analogue, that hybridizes to the analyte nucleic acid.

The dye need not detach from the selective agent upon introduction of the analyte. Instead the selective agent may change configuration upon binding of the analyte such that the dye moves into a new position closer to the metal, thereby resulting in an increase to the Raman signal. It is also possible that the dye is initially held in a position close enough to the metal surface to produce a SERRS signal, but is displaced in the presence of an analyte to be detected, e.g. by binding to a selective agent and displacing the dye from its position near the metal surface. In this instance, rather than looking for an increase in the Raman radiation emitted, it is the reduction in the Raman radiation that allows the absence, presence or quantity to be determined.

The analyte itself may be intrinsically Raman-active. In such embodiments the dye may be chemically identical to the analyte and the presence, absence or quantity of analyte can be determined directly from its Raman signal. Therefore the term “dye” may also include an analyte.

The term “antibody” is used herein to include an antibody, or a fragment (for example a Fab fragment, Fd fragment, Fv fragment, dAb fragment, a F(ab′)2 fragment, a single chain Fv molecule, or a CDR region), or derivative of an antibody or fragment that can selectively bind an analyte to allow detection of the analyte.

In general, it is expected that the components of the dye will be linked together by separate linkers. It will be apparent to the skilled person that there are many possible suitable linkers that could be used. The identity of the linkers will depend on the identity of the components of the dye. If the selective agent binding group comprises a peptide, it is advantageous if the linker is compatible with conventional peptide linking chemistry. For example, the linker may preferably comprise a single carboxylic acid group for reaction with the N-terminus of the peptide.

In some circumstances, depending on the particular components used, it may be possible to link two or more components of the dye together without use of a separate linker, for example by reaction between chemical groups of different components of the dye.

The components of the dye may be linked together in any order, provided that when the dye is bound to the surface by means of its metal surface-binding group, the dye is within the region near the metal surface.

The metal surface-binding group of the dye should be a group that binds preferentially (typically by adsorption) to the metal surface. In some circumstances, it may be desired that binding of the metal surface-binding group to the metal surface is sufficiently strong enough to immobilize the dye to the metal surface. The chemical nature of the metal surface-binding group will depend on the metal surface that is used. Suitable silver binding functional groups include groups having a heterocyclic nitrogen, such as oxazoles, thiazoles, diazoles, triazoles, oxadiazoles, thiadiazoles, oxathiazoles, thiatriazoles, benzotriazoles, tetrazoles, benzimidazoles, indazoles, isoindazoles, benzodiazoles or benzisodiazoles. Other suitable functional groups include amines, amides, thiols, sulphates, thiosulphates, phosphates, thiophosphates, hydroxyls, carbonyls, carboxylates, and thiocarbamates. Amino acids such as cysteine, histidine, lysine, arginine, aspartic acid, glutamic acid, glutamine or arginine also confer silver binding.

The term reaction carrier is used to define the container into which an analyte to be detected is introduced and within which the support material is located.

### BRIEF DESCRIPTION OF THE FIGURES

An embodiment of the invention will now be described, by way of example only, and with reference to the accompanying drawings, in which:

FIG. 1 shows a conventional microfluidic SER(R)S sensor;

FIG. 2 shows a plot of the Stokes' radius plotted against molecular weight for various proteins;

FIG. 3 shows the calculated diffusion coefficient for various proteins plotted against molecular weight;

FIG. 4 shows a diagram of a known biosensor model;

FIG. 5 shows plots used to calculate the concentrations of analyte at various depths in the biosensor model of FIG. 4;

FIG. 6 shows a plot of chamber height against time for 99% binding of an analyte to a binding partner to occur;

FIG. 7 shows a calculated binding amount over 1 hour for a typical 100 kDa protein for different chamber heights;

FIG. 8 shows a microfluidic SER(R)S sensor embodying the invention;

FIG. 9 shows the focussing characteristics of a laser being focussed onto a mirror (left) and into a volume (right) as could be employed in the embodiment of the invention in FIG. 8;

FIG. 10 shows a fine-grained three-dimensional support matrix in the form of a filter frit;

FIG. 11 shows the silica grains of a filter frit coated with particulate metallic silver as may be employed with an embodiment of the invention such as that of FIG. 8;

FIG. 12 shows diagrammatically the silica grains of the filter frit of FIG. 11 coated with particulate metallic silver;

FIG. 13 shows a morphology of deposited silver comprising of filamentous strands formed by a first deposition method in accordance with an aspect of the invention;

FIG. 14 shows a second morphology of deposited silver;

FIG. 15 shows an increased number of silver depositions per unit area obtained by a second deposition method in accordance with a further aspect of the invention;

FIG. 16 shows a plot of silver particle sizes obtained by two deposition methods overlaid together;

FIG. 17 shows example SERRS spectra from particles prepared on silica filters such as that shown in FIG. 11 using two different methods;

FIG. 18 shows controlled pore glass particles of approximately 80-120 μm in size;

FIG. 19 shows a close up of the surface of a single controlled pore glass particle;

FIG. 20 shows a close up of the surface of a single controlled pore glass particle at a higher magnification than FIG. 19 showing void dimensions of approximately 200-500 nm;

FIG. 21 shows that metal particles may be deposited within the voids shown in FIG. 20;

FIG. 22 shows the UV/visible absorbance profile for a surface covered with particles of given sizes and shapes;

FIG. 23 shows the calculated values of λₘₐₓ plotted against the measured values and;

FIG. 24 shows predict λₘₐₓ values for silver particles of various widths and heights.

FIG. 25 shows the absorbance of a support material in accordance with an embodiment of the invention for a given wavelength of radiation compared with a theoretical value.

FIG. 26 shows the plot of FIG. 25 with an additional term used in the theoretical calculations.

### DESCRIPTION OF EMBODIMENTS OF THE INVENTION

The embodiments described feature an improved substrate for use in spectroscopy. The invention uses a metal distributed within a fine-grained three-dimensional support material to produce a substrate with optimal characteristics for SERS and SERRS. Bringing the metal physically closer to the analyte molecules in solution reduces the diffusion path lengths and can achieve a decrease in assay times, as well as increasing the available metal surface area accessible to the analyte molecules in a given volume of solution. In addition, the Raman illumination laser samples a 3D volume rather than a 2D surface, with benefits not just for signal intensity but also for addressing engineering problems such as focussing. Also, the engineering constraints on the supporting biosensor chip can be relaxed somewhat, since it is the nature of the support material, rather than the reaction carrier dimensions, which has the biggest influence on the sensor performance.

An embodiment of this invention is realised by chemically depositing portions of metal within a support material. Several benefits can be achieved by this, including enhanced sensitivity, prolonged stability of photolabile chromophores, and a vastly reduced assay time. As a preferred feature the metal portions deposited within the support material to form the Raman enhancing surface are silver. The support material is a solid, for example in the form of a silica filter, but this is not a requirement and the support material may, for example, be in the form of a powder or glass balls. A main requirement of the support material is that it keeps the Raman enhancing surface immobilised within the reaction carrier.

A method of producing an improved substrate, using silver deposition chemistry, will now be described and is based on an analytical test for carbohydrates which was developed by the German chemist Bernhard Tollens (1841-1918), and which now bears his name. It will be appreciated by someone skilled in the art that this is not the only means of depositing a metal on a surface and that other methods are within the scope of the invention. It will be further appreciated that whilst silver exhibits many desirable features for use as a Raman enhancing surface in spectroscopy other substances can be used such as, for example, gold and copper. Also, using combinations of these metals may infer advantages on the flexibility of the invention and are discussed below.

Tollens' reaction is a multi-stage process, involving the oxidation of an aldehyde to the carboxylic acid, and reduction of aqueous silver ions to the metal. First, silver hydroxide is prepared from silver nitrate by reacting with sodium hydroxide:

AgNO₃+NaOH→AgOH+NaNO₃

The hydroxide forms a brown-black precipitate which usually also contains silver oxide. Adding ammonium hydroxide produces a silver diamine complex, as a colourless solution:

AgOH+2NH₄OH→[Ag(NH₃)₂]⁺+OH⁻+H₂O

The diamine complex is stable in aqueous solution and can be stored until needed. The silver deposition process is initiated by adding an aldehyde. The aldehyde reacts with hydroxyl ions in the alkali solution causing it to be oxidised to a carboxylic acid and releasing two electrons:

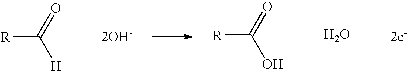

The aldehyde can come from a variety of sources. In the traditional Tollens reaction, a glucose solution is used. Like most sugars, glucose can exist in a closed-ring or an open-chain form. In water solution both forms are in equilibrium:

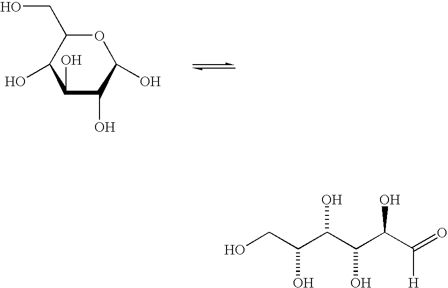

The electrons released by the oxidation of the aldehyde can each then reduce a silver diamine complex to give metallic silver and free ammonia:

[Ag(NH₃)₂]⁺+e⁻→Ag+2NH₃

This redox reaction can be summarised as:

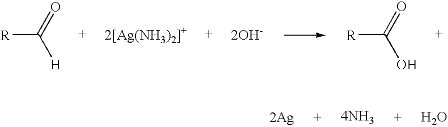

The reduced silver atoms are unstable in aqueous solution, and quickly come together to give metallic silver. If an appropriate solid surface is available, the metal will form at the interface between the surface and the solution. In the traditional Tollens' test for sugars, a clean glass surface is used, and the silver forms a confluent, mirror-like film in a matter of minutes.

Depending on the specific reaction conditions, which are dependent on the analyte in question, and the nature of the available support material, the Raman enhancing surface (preferably silver) may form a suspension of micro to nanometre scale particles, particle clusters, and particles deposited on the support material and within any voids present in the support material.

The abovementioned process is just one method of producing a support material in accordance with the invention. Other methods can be employed including, for example, immobilising silver colloids on or within the support structure.

It is preferred that the support material is a fine-grained, porous, three-dimensional support matrix chosen to have the optical properties of glass. For example, the support material may be in the form of glass balls filling a portion of the reaction carrier. In particular, the support material should not be fluorescent (which would give an unacceptable background interference to the Raman spectra), would ideally be a very biocompatible material, and should not contribute a substantial Raman signals of its own, or at least not within the frequency range of the Raman response of the dye, since this would obscure the Raman signal from the dye. Silica is ideal for these purposes but it should be appreciated that other materials with similar properties could be used without straying from the scope of the invention. Examples of other materials that may be used to form the support material include ceramics, plastics or aerogels.

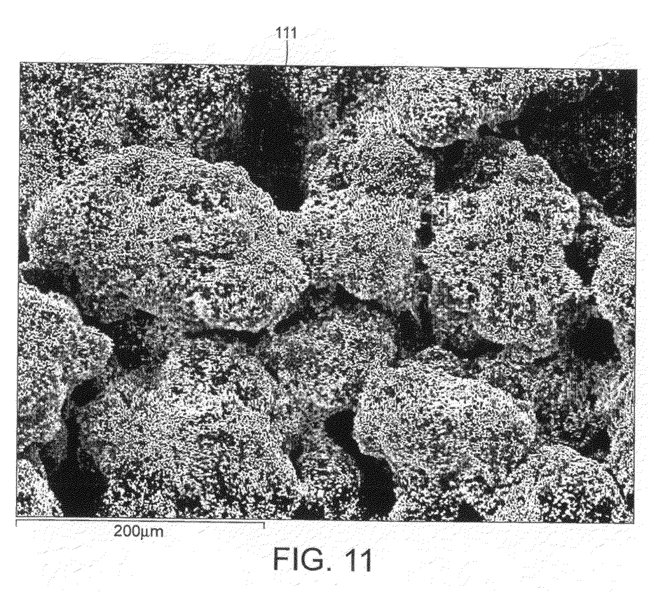

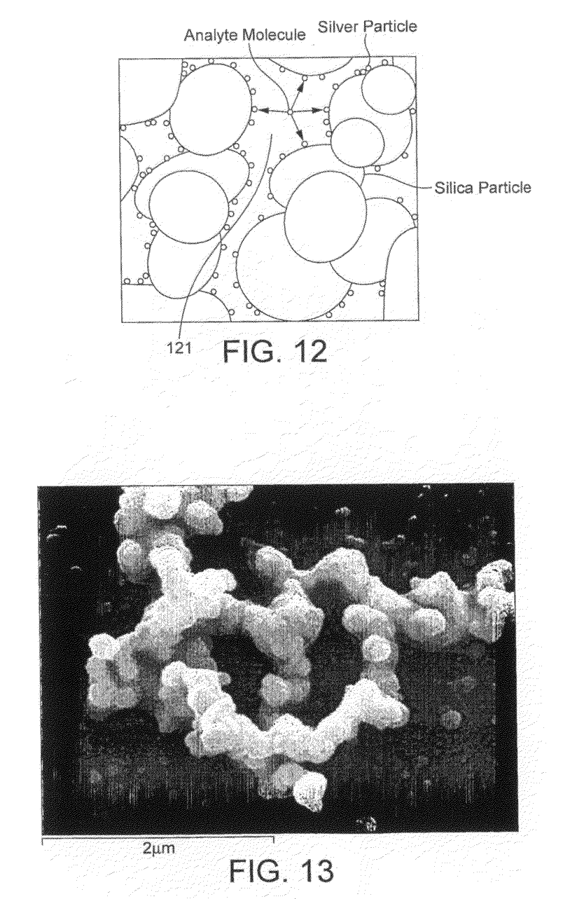

The support material defines a volume within which the silver particles may be distributed. In one embodiment the silver particles are deposited on the outside of the individual substrate particles that comprise the support material. An example of this can be seen in FIGS. 11 and 12, wherein silica substrate particles defining a volume have silver particles deposited on them. This means that silver particles are present within the voids (111, 121) between the particles comprising the support material. A further example would be a support material comprised of a collection of glass balls, having silver deposited thereon. Gaps, or voids, between adjacent balls, or substrate particles, result in the support material being porous and having silver particles immobilised throughout the support material.

An additional embodiment is described below in which the substrate particles comprising the support material are themselves porous to the dye and have silver particles deposited within their internal structure.

A 3D porous material such as silica provides a volume with a much larger internal surface area compared to a flat surface, so there is a much greater surface available for molecular adsorption. Also, instead of illuminating a planar surface spot, the incident laser illuminates a volume within the material, further increasing the surface area that is interrogated by the Raman laser. Both of these factors result in a large increase in the number of SERRS-active molecules within the illumination beam, with a consequent improvement in signal strength.

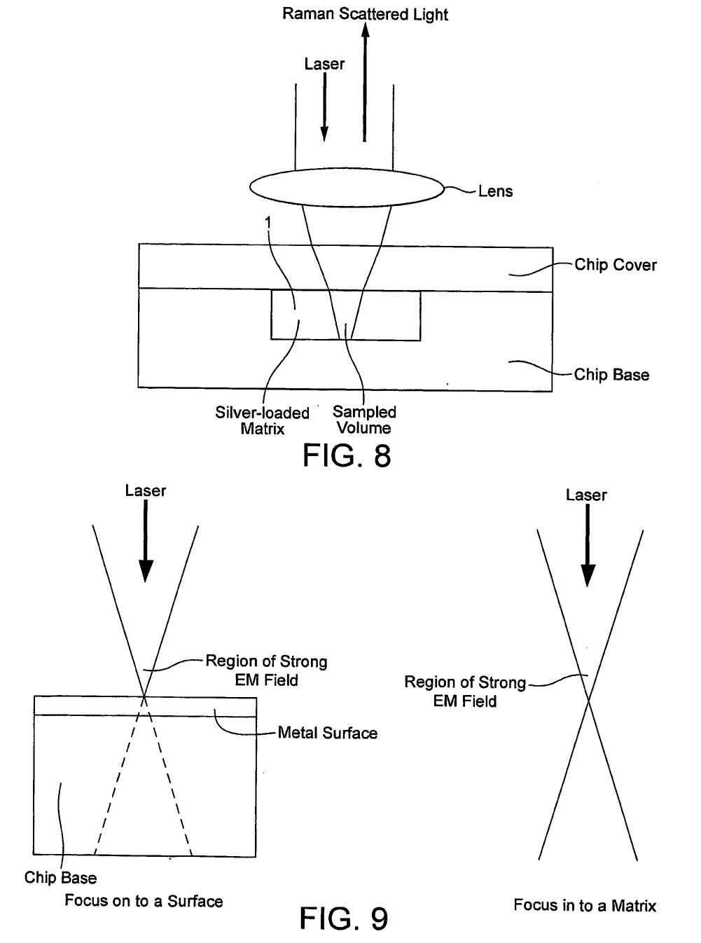

FIG. 8 shows a microfluidic SER(R)S detector arrangement embodying the invention. The detector arrangement is comprised of a reaction carrier containing a dye, an illumination source in the form of a laser and a detector. A 3D porous material such as silica, with metal particles deposited within it, is provided within the reaction carrier. Since the laser is interrogating a volume rather than a plane, precise focusing onto the sample becomes less important. Indeed, as indicated in FIG. 9, because the laser beam is focused into a cone, passes through the focal point, and then expands into a cone beyond this point, the molecules immediately in front of and behind the focal point are in a relatively strong electromagnetic field. In the idealised case, there will be twice the number of molecules in a strong field when the focal point is within the matrix compared to when the focal point is at a planar surface, so the Raman signal should be doubled.

A planar metal surface may act as a mirror, in which case the molecules in front of the focal point will be in an enhanced EM field (from both the incident beam and its reflection). Where the beams interfere constructively, the molecules will be in a double-strength field. Since Raman intensity is proportional to the square of the field strength, molecules in a doubled field will emit four times the Raman signal. However, half of the molecules will be in regions where the fields interfere destructively, so will contribute nothing to the Raman signal. Overall, the Raman scattering intensity will therefore be twice what it would be without a reflective surface. However, this signal is coming from molecules in a doubled field, so they will consequently photodegrade at a higher rate. Photodegradation occurs when a chromophore is permanently damaged due to photon-induced excitation and subsequent covalent modification. Upon transition from an excited singlet state to the excited triplet state, chromophores are more likely to interact with another molecule to produce irreversible covalent modifications. The triplet state is relatively long-lived with respect to the singlet state, thereby allowing excited molecules a much longer timeframe to undergo chemical reactions with components in the environment. For a given surface area, the within-matrix focus arrangement can therefore give the same intensity of Raman signal as a reflective surface but confers the benefit of a reduced photodegradation rate of the chromophores. If the surface is non-reflective, the matrix arrangement would provide an enhanced signal.

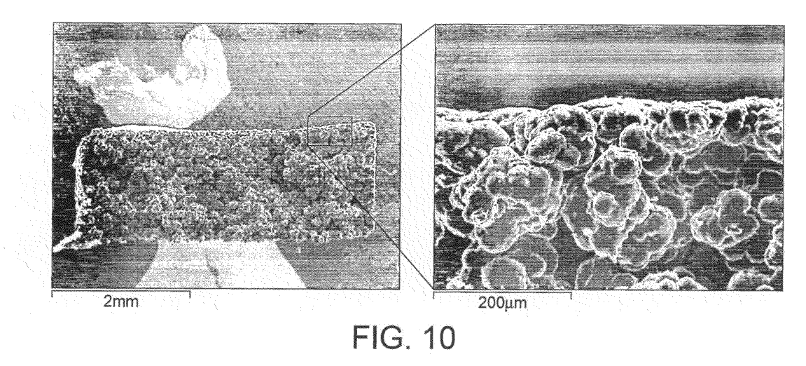

The fine-grained three-dimensional support matrix can be in the form of a silica filter frit (shown, in cross-section in FIG. 10), which has a porous structure, with voids of several tens of micrometres between rounded grains of silica. When used as a support surface for the chemically deposited silver, the silica grains become coated with particulate metallic silver, as shown in FIG. 11 and, diagrammatically in FIG. 12.

The matrix voids 111/121 may be, typically, approximately 50-80 μm across, resulting in diffusion paths of 25-40 μm. For a typical 100 kDa protein analyte, this would result in 99% binding within approximately 30 seconds. The 3D matrix confers the reaction speed advantage of a microfluidic system whilst simultaneously enabling the detection volume to be on the millimetre scale or larger due to the relaxed requirements on the laser focusing.

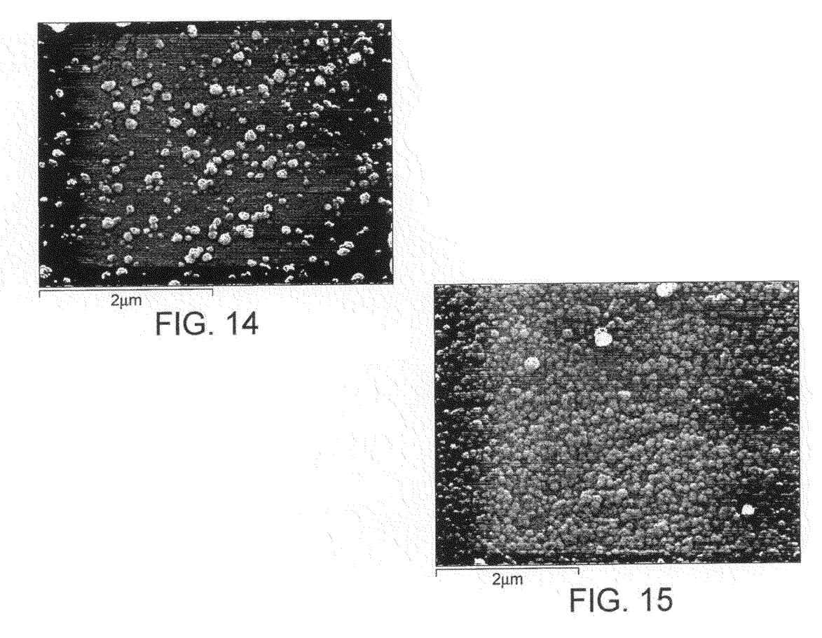

The deposited metal portions have two morphologies. The first form comprises filamentous strands, shown in FIG. 13, which are fused linear chains of roughly spherical particles having a diameter of approximately 250 nm. These filaments are surrounded by a second form of smaller, isolated particles ranging in size from a few tens to a few hundreds of nanometres, as shown in FIG. 14. It should be appreciated that other morphologies formed from different methods would also work.

FIG. 14 shows 510 approximately spherical silver particles with diameters ranging from ˜12 nm to ˜220 nm. The method required to produce this deposition involves completely immersing the filter frit in the Tollens' reaction mixture.

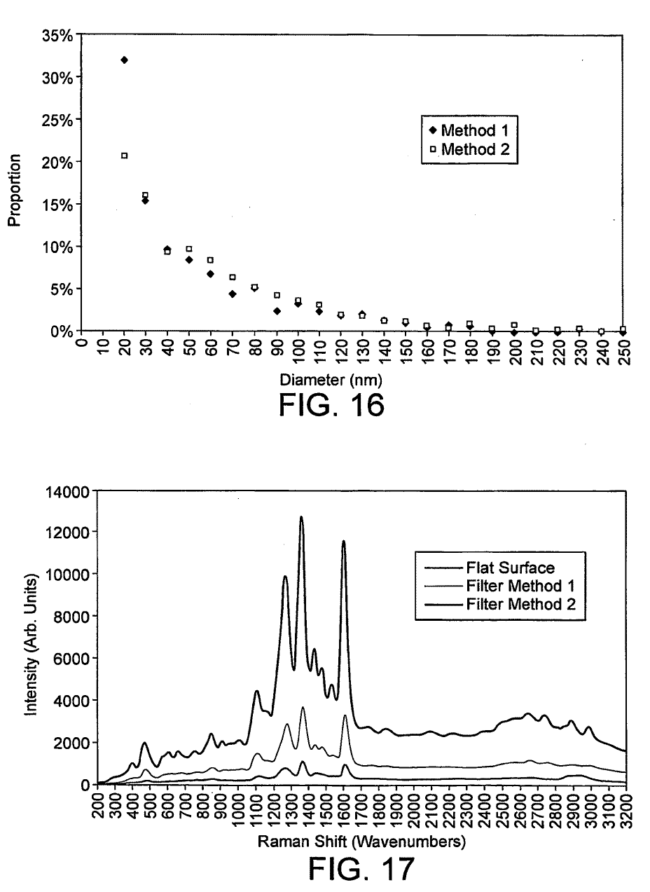

If the frit is allowed to float on the surface of the reaction mixture, silver particles are deposited with a much higher density per unit area as illustrated in FIG. 15. Although FIG. 15 shows a higher surface density of particles (there are 976 in FIG. 15 compared to 510 in FIG. 14), they have a very similar size distribution to those produced by full submersion of the filter frit, as can be seen by plotting the particle size distributions overlaid together (FIG. 16). Partial submersion of the filter frit produces nearly twice as many particles per unit surface area as method 1, and so provides a higher Raman signal.

Example SERRS spectra from particles prepared on silica filters using the two methods, and on a flat surface, are shown in FIG. 17. In all cases, the same SERRS-active compound was used at a concentration of 10⁻⁵ M, with an integration time of 1 second. Filter method 1 refers to the case where the frit is fully submerged in the reaction mixture; method 2 refers to the case where the frit is allowed to float at the surface.

Although there are about twice the number of silver particles on the surface prepared by using a floating frit, the SERRS signal is some 3× greater than that from method 1. This is because the signal intensity is not linearly dependent on the number of particles at the surface. Since the particles follow the same size distribution, the disproportionately increased SERRS signal cannot simply be due to the increase in available silver surface, but must have an extra contribution due to an interaction between particles, with the higher packing density leading to an additional SERRS enhancement. It is generally accepted that the particles interact via electromagnetic fields generated by a synchronised motion of conduction electrons within them, and that this interaction is dependent on the distance between particles.

In a further embodiment of the invention it is possible to reduce the average diffusion path length of analyte molecules even further by depositing silver particles within the structure of the substrate particles comprising the support material itself. This can be achieved if the support material is porous. The term porous, in this instance, refers to materials containing pores of a size such that the particles making up the material are porous to the dye being used to detect the analyte. In this embodiment the substrate particles of the support material themselves have voids, or pores, resulting in a completely accessible internal structure.

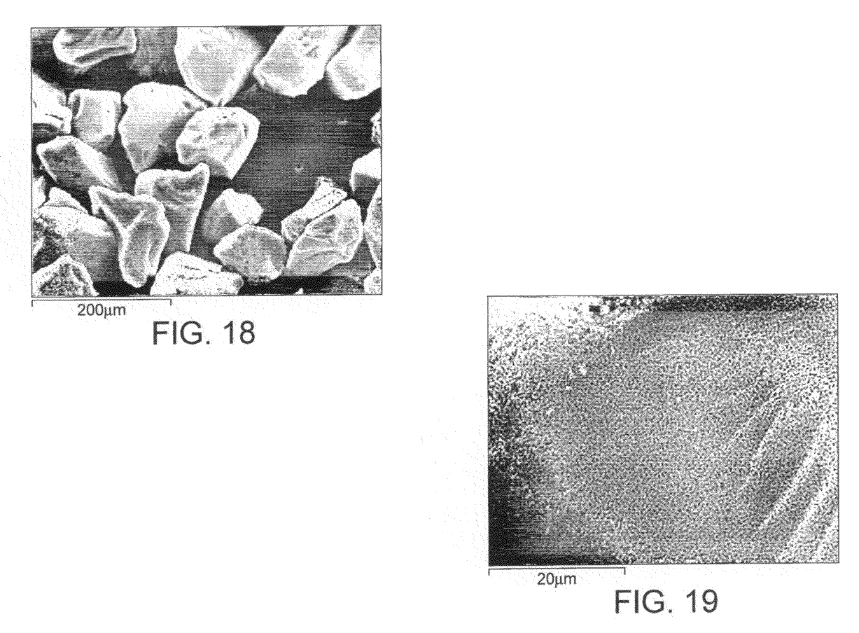

A good example of a support material made from micro-porous particles is controlled pore glass (CPG) and can be formed from silica. Micro-porous refers to the fact that the pores have a size of the order of several microns, or tens of microns. One method of producing CPG is by acid etching a mixture of glasses wherein one of the glasses is susceptible to corrosion by acid whilst the other is not. The result is a glass/silica material featuring a completely accessible internal structure, the individual silica particles having voids on the nanometre scale that serve to increase the internal surface area available for silver particles to adhere to. An example of such a material is shown in FIGS. 18-21.

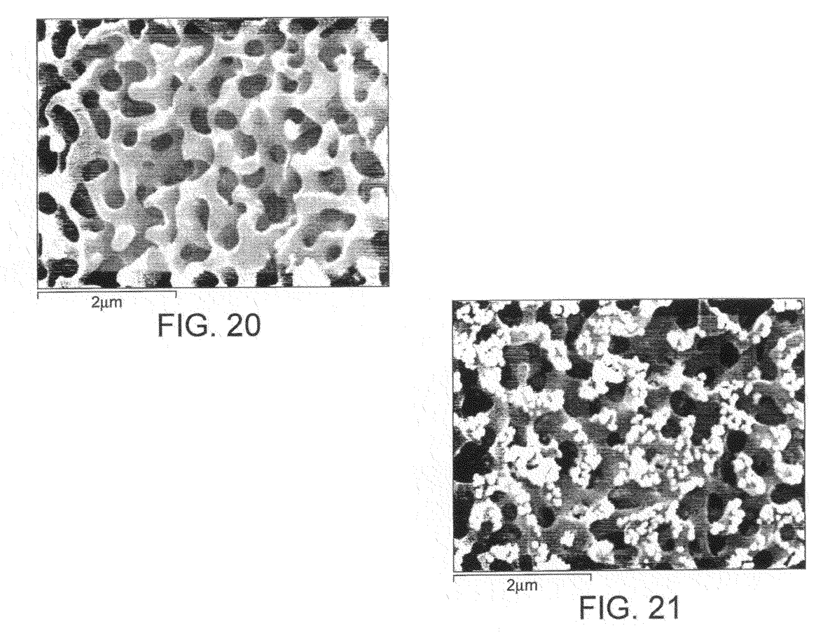

FIG. 18 shows a magnified view of CPG in which individual particles can be seen. FIG. 19 shows the surface of a single grain, revealing that the surface is marked with many voids that are interconnected, providing a completely accessible internal structure. FIG. 20 shows a higher magnification view of the surface of the CPG particle allowing the size of the voids to be made out (in this case a few hundred nm) and FIG. 21 shows that metal particles may be deposited within the voids. The typical size of metal particles suitable for use in material such as CPG is around 50 to 150 nm.

CPG is widely used as a support matrix for chemical synthesis. Several grades are available, differing in particle size (CPG is usually handled as a particulate powder), void size (typically ranging from ˜100 nm to ˜1 μm) and surface derivatisation (a wide variety of functional groups, to facilitate chemical attachment to the surface). CPG is particularly suitable as a biosensor support matrix since it has a large internal surface area (up to 100 m²/g or more), is chemically inert (unless derivatised to improve its metal binding or particle seeding properties), and does not give rise to substantial Raman peaks, which can cause spectral interference.

The voids should be large enough for the dye to enter and also to accommodate the metal portions/particles. Typical dyes have a size of approximately 1-5 nm, and analytes 5-100 nm. When using metal particles of around 50 nm in size, this means that the void size should be around 150 nm or more.

As an example, one method to make a silver based substrate is to perform the Tollens reaction in the presence of CPG. Surface derivatisation of the CPG with aldehyde, alcohol, or carboxylate groups are particularly suitable for this method

In all embodiments of the invention, the support material may be porous to the analyte to be detected, with the detection chemistry (such as displacement of a reporter molecule or dye by the analyte) occurring within the support structure itself. However, this is not a requirement of the invention. The support material may only be porous to the dye, depending upon the analyte to be detected, and not porous to the analyte or other materials in a sample. Other materials may include anything within the sample that it is not desired to detect, or that it is desired to keep away from the illuminated portion. Examples may include blood cells, or chemicals that may distort the Raman signal. The analyte could displace the dye at the external surface of the support material and the dye may then diffuse into the support material to interact with the Raman enhancing metal particles. The minimum requirement is for the support material to be porous to the dye. Furthermore, the substrate particles may be porous to the dye but not the other materials in the analyte sample. The analyte could displace the dye at the external surface of the support material, or within the support material but outside the substrate particles, and the dye may then diffuse into the substrate particles to interact with the Raman enhancing metal particles.

Where the support structure or substrate particles are only porous to the dye, the analyte may displace the dye from a selective agent at the external surface of the support material or substrate particles. The dye will then diffuse into the support material or substrate particles to interact with the silver particles distributed therein. Of course, in cases where the analyte is also a dye itself there is no need for a separate dye and the support material or substrate particles will be porous to the analyte itself. The analyte, when introduced into the reaction carrier, will diffuse into the support material or substrate particles and interact with the silver particles.

The size of the pores/voids of the support material or substrate particles controls the distribution of Raman enhancing particles throughout the material and the distance a dye must travel to interact with a Raman enhancing surface. Consequently, the void/pore size throughout the support structure should be of the same order of magnitude as the mean free path of the dye being used. The required sizes may be determined from the diffusion coefficients shown in FIG. 3.

The distribution of Raman enhancing particles within the voids should, as a preferred feature, be such that the distances between neighbouring metal particles are of the same order as the mean free path of the dye whose Raman response is to be detected.

When a material such as CPG is used, having a large internal surface area, the distance a molecule must diffuse to interact with a metal particle can be large since the pores within the particles can be from 100 nm up to 10,000 nm. When depositing metal within such a structure using methods such as crystallisation or deposition, the distribution of metal particles follows a radial distribution function. Further into the structure, fewer metal particles are present to interact with the dye. However, the dye also diffuses in a similar manner and therefore the majority of dye molecules will be found in regions having high concentrations of metal particles.

A 3D porous support in accordance with the invention experiences two levels of resonance when illuminated by a laser. Firstly there is the surface plasmon resonance experienced by the individual metal particles. In addition, there is also a larger scale resonance resulting from what is essentially a metal placed in a dielectric medium (the sample and the support material). This second resonance level shares similarities with resonance within photonic crystal structures, however the overall dispersion of metal particles within the support structure is not uniform so a direct comparison is difficult.

A support structure having metal distributed and immobilised within it, such as CPG loaded with silver, may to a reasonable approximation (for calculation purposes only) be regarded as being equivalent to a physically immobilised colloidal dispersion. The CPG and sample solution within the voids approximate a dielectric medium, with the metal nanoparticles lining the walls of the CPG internal voids being equivalent to colloidal particles in suspension. The dimensions of the voids and spatial dispersion of nanoparticles on the void walls determine the ‘concentration’ of the colloid analogue.

Optical properties of colloidal particles have been extensively studied. The absorption spectra of colloids can be calculated from Mie theory. For small spherical particles, the absorbance A for a dispersion of N particles per unit volume depends only on the dipole term in the Mie summation, and can be calculated as

$$A = \frac{CNl}{2.303}$$

where C and I are the absorption cross-section and optical path length respectively. If the particle dimensions are smaller than the mean free path of the conduction electrons, then these electrons will ‘collide’ with the particle walls, giving a lower effective mean free path than that in the bulk material.

In the limit 2πR<λ (where R is the particle radius and λ is the wavelength of light in the surrounding medium), the cross section can be expressed as

$$C = \frac{18 π V {ɛ}_{2} ( ω ) {ɛ}_{m}^{3 / 2}}{λ [ {( {ɛ}_{1} ( ω ) + 2 {ɛ}_{m} )}^{2} + {{ɛ}_{2} ( ω )}^{2} ]}$$

where V is the volume of a spherical particle, λ is the incident wavelength (corresponding to a frequency ω) and εₘ is the permittivity of the medium. The complex relative permittivity of a bulk metal is given by

ε(ω)=ε₁(ω)+iε₂(ω)

For free-electron metals such as silver, ε₁(ω) and ε₂(ω) are often well known, having been determined experimentally over a range of wavelengths. From the above equations, it can be seen that a maximum occurs in the absorbance when ε₁(ω)=−2εₘ. The value of ε₂(ω) when ε₁(ω)=−2εₘ, and the rate of change of ε₁(ω) with wavelength is a factor determining the height and width of the resulting absorption band.

For metal particles with sizes comparable to the mean free path of the conduction electrons (L) the collision rate between the free electrons and the particle walls becomes appreciable. The electron motions are effectively damped, leading to a change in the dielectric properties of the metal. To account for this surface effect, a second term needs to be added to the calculation of the imaginary part of the dielectric function:

$${ɛ}_{{2}^{′}} ( ω ) = {ɛ}_{2} ( ω ) + \frac{L}{R}$$

where ε_{2′}(ω) is the dielectric parameter corrected for small particles.

As described previously, typical silver particles, as may be distributed on and within a support material provided by the invention, are several tens of nanometres in diameter. A commonly accepted value for L, the mean free path of electrons, in silver is approximately 57 nm. Wavelength-dependent values for the complex dielectric functions for silver, glass and water (a good approximation to a sample) are well known in the field. Using these data, the UV/visible absorption spectrum for silver-loaded CPG can be predicted.

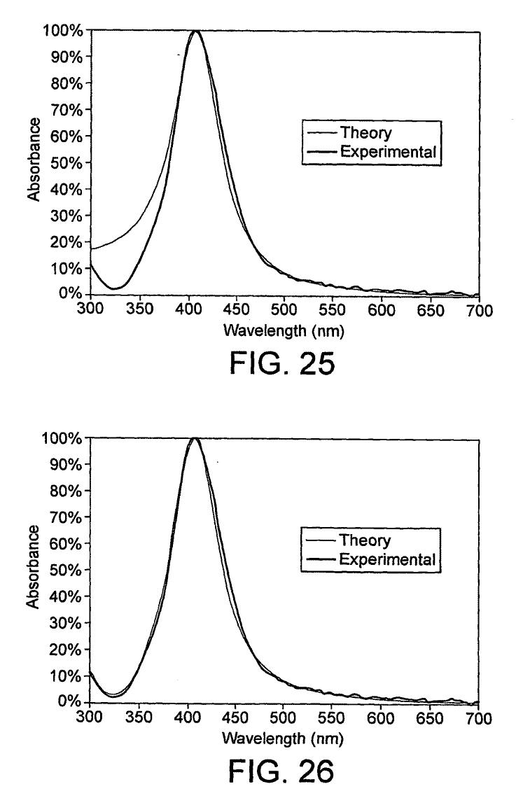

A comparison between the theoretical and experimental results can be seen in FIG. 25, but the experimental absorbance at short wavelengths is lower than predicted. This difference can readily be corrected by subtracting a Gaussian function of the form

$$f ( x ) = a {e}^{\frac{- {( λ - b )}^{2}}{{σ}^{2}}}$$

The optimal fit to the experimental data, shown below, is found with a=7×10⁻⁶, b=3.34×10⁻⁷ and c=3.5×10⁻⁸.

The parameter a is simply a scaling factor. The b and c parameters respectively determine the position and width of the Gaussian peak. Subtracting this Gaussian has the effect of applying a ‘notch’ filter to the optical spectrum. This effect can be rationalised if the silver-loaded CPG behaves similarly to a photonic crystal with an excluded band-gap at around 334 nm. The experimental data was collected using a laser of nominal wavelength 532 nm (in a vacuum). The ratio of the nominal to apparent wavelengths (532/334) gives an effective refractive index for the silver-loaded CPG ‘photonic crystal’ of 1.593. The refractive indices of glass, water and silver at this nominal wavelength are approximately 1.520, 1.336, and 0.002 respectively. The silver-loaded CPG is therefore acting as a metamaterial with properties differing from those of its constituent materials.

The geometric dispersion of silver particles within CPG is not a regular crystalline lattice, so conventional theory describing photonic crystals does not necessarily apply. However, there is a degree of local regularity in the particle dispersion, primarily determined by the void size and inter-void spacing within the CPG structure. The situation is further complicated by the fact that the particles are separated not by a uniform dielectric medium, but by a combination of voids filled with the sample (a dilute aqueous solution with undetermined dielectric properties containing at least the dye to be detected and possibly analyte, and other chemicals that are not to be detected), and the inter-void material comprising, in this instance, glass. The exact dielectric properties of a material such as this will to a large degree depend on the precise geometry and spatial configuration of the CPG voids, and a general analytical description is difficult to derive. However, the behaviour of a silver-loaded CPG matrix is predictable using numerical techniques such as finite element analysis or mesh-free methods.

The optical behaviour of the sensing material is therefore determined by two fundamental mechanisms. The first, surface plasmon resonance, is primarily influenced by the size, composition and geometries of the metal particles themselves. The second larger scale resonance is influenced by the composition and spatial distribution of the support matrix, which in turn determines the spatial distribution and dielectric environment in which the metal particles are dispersed. The optical properties of the metal particles themselves can be predicted (and thereby rationally engineered) by using the mathematical techniques described above. The optical properties of the metal-loaded matrix material can be determined by analytical or numerical approaches as appropriate to the complexity of the structure. The differing refractive indices and dielectric properties of the support material and the sample determine the optimal spacing between metal particles required to ensure maximum absorbance of the incident radiation. The average spacing of the metal particles should ideally be half the wavelength of the incident radiation, however the wavelength is dependent upon the material through which the radiation is passing. The ratio of the void diameter to the wall thickness of the support material should preferably equal the ratio of the refractive index of the solution filling the voids and the refractive index of the support material, in which case the actual wavelengths of the excitation photons in both materials would be the same. Consequently, the dimensions of the void/wall structure in the CPG metamaterial should preferably be selected as a weighted average to account for the difference in the volume of the support material comprising voids and the volume comprising solid support material. A spacing of metal particles that is a multiple of half the wavelength of the incident radiation will also give additional resonance harmonics.

Lasers used in Raman spectroscopy typically have a focal area of around 100 μm, although this may extend to as large as 500 μm. FIG. 18 shows that the sizes of CPG particles may be on the order of 100 microns across. It should therefore be appreciated that a support material in accordance with the invention could include a single substrate particle having a porous structure with a metal immobilised and distributed therein. Ideally as few particles are used as possible since a large number of particles effectively dilutes the sample concentration. Larger numbers of particles may be used for convenience to simplify the engineering/construction of a detector incorporating the invention.

Whilst lasers are typically used in Raman spectroscopy the only requirement is that the source of illumination is monochromatic, having a specified wavelength. There is no requirement for the illumination source to be coherent.

The sizes of the voids can affect the illuminating light if the void size is approximately the same as the wavelength of light used. By using void sizes that are sufficiently less than the wavelength of the light these problems are reduced.

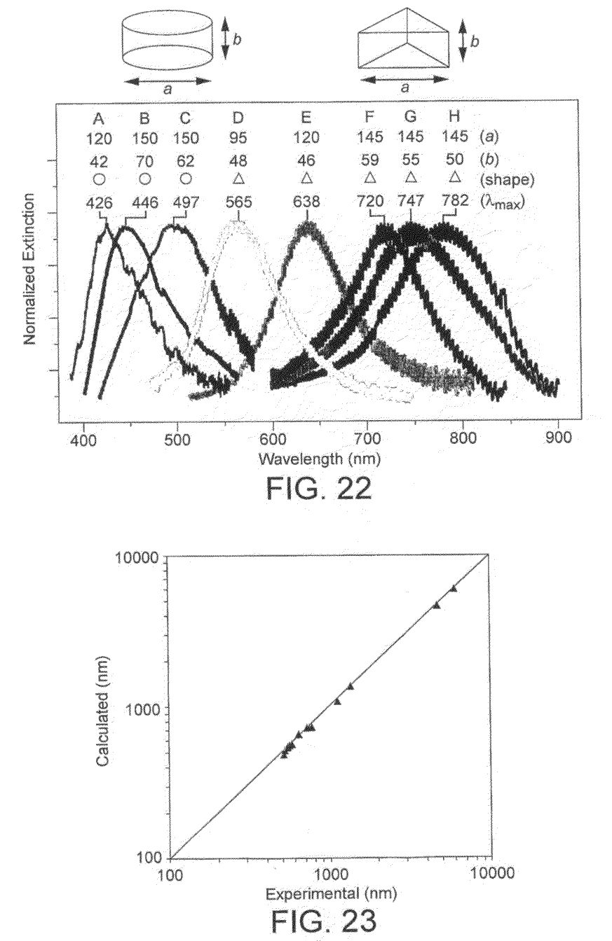

Particle size and shape has a dramatic influence on the ability of the metal particles to couple with the incident laser via resonance with the plasma of conduction electrons at their surfaces (the plasmons). Experimental evidence of this is shown in FIG. 22 (taken from Haes et al., MRS Bulletin (30), May 2005).

FIG. 22 shows the UV/visible absorbance profile for a surface covered with particles of the given sizes and shapes. The most complete data set currently available, which covers both UV/visible and infrared regions, is for triangular particles, and is shown in the table below:

| Width | Height | |
|---|---|---|
| (nm) | (nm) | λₘₐₓ (nm) |
| 90 | 46 | 565 |
| 120 | 46 | 638 |
| 145 | 59 | 720 |
| 145 | 55 | 747 |
| 145 | 50 | 782 |
| 90 | 58 | 501 |
| 90 | 53 | 517 |
| 90 | 43 | 533 |
| 90 | 38 | 544 |
| 90 | 33 | 563 |
| 90 | 23 | 585 |
| 240 | 22 | 1125 |
| 323 | 28 | 1364 |
| 897 | 65 | 4739 |
| 830 | 50 | 6042 |

By applying non-linear regression modelling to the triangular particle data, an empirical equation relating λₘₐₓ to the particle width and height can be derived:

λₘₐₓ=(3.703319918×Width)+(0.000026746×Width³)−(0.00218472×Height³)−(0.000464139×Width^{2*}Height)+(0.001779672×Height^{2*}Width)+242.638583311

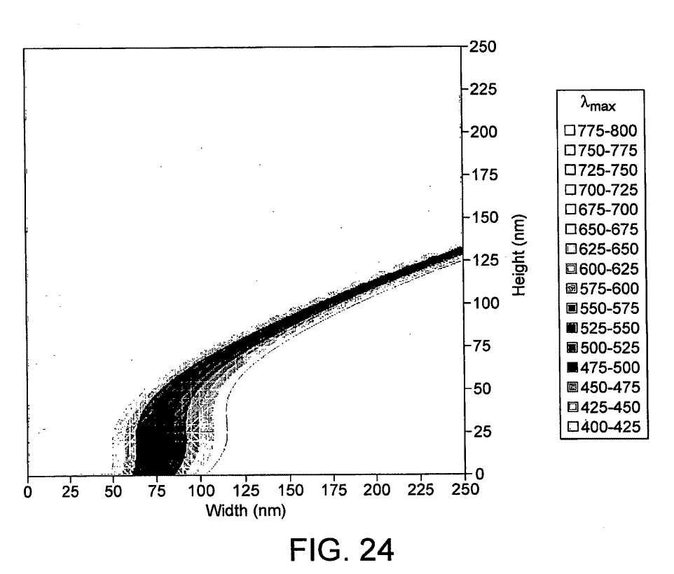

This gives a reasonably good fit to the experimental data as shown in FIG. 23 which shows the calculated values of λₘₐₓ plotted against the measured values. This relationship strictly only applies for triangular particles and is based on a relatively small number of experimental data points, so its accuracy would be much improved if more observations were available. In particular, its accuracy will be much reduced for combinations of Width and Height that lie well outside the ranges observed experimentally. Given these caveats, however, it is possible to predict approximate λₘₐₓ values for silver particles of various widths and heights. The dark contours in the plot of FIG. 24 indicate a better coupling to the commonly used 532 nm laser.

FIG. 24 is not symmetrical with respect to width and height because the particle system observed relates to a 2D planar array of particles. The particle fields interact strongly in the plane of the surface, but not in out-of-plane directions so ‘width’ relates to the particles' in-plane dimensions, and ‘height’ to their size normal to the plane.

There is a particle width (˜100 nm) above which λₘₐₓ becomes unacceptably greater than 532 nm. Particles with relatively small widths (<˜50 nm) have unacceptably low predicted values for λₘₐₓ. For particle widths greater than about 100 nm the optimum height for resonance with a 532 nm laser (Height≈25+0.42×Width). Particles with a width of around 75 nm have optimal heights between below 50 nm, and particles with widths below 75 nm have sub-optimal λₘₐₓ values less than 532 nm. There is therefore a narrow range of dimensions within which particles of a particular size attached to a surface will exhibit good optical extinction for a specified laser wavelength.

Particles formed by deposition using Tollens reactions will have a range of different sizes, these sizes being distributed by fractal dispersion. One benefit of such a range of sizes is that it ensures there will be a proportion of particles having the appropriate size to provide an enhancement to the response of the dye to illumination from radiation. With Raman spectroscopy this works by the plasmon wavelength being matched to the wavelength of the incoming radiation. It would, however, further increase the surface enhanced Raman effect if only particles of the required size were uniformly distributed on the surface of the substrate. This can be achieved by immobilising silver colloids within the support material since the size of such colloids can be controlled to a greater extent than silver particles produced through deposition techniques.

Assuming that the particles deposited by the Tollens' reaction approximate to particles where a=b=observed diameter, we can estimate that the surface-enhanced Raman signal from a population with the size distribution shown in FIG. 24 is mostly coming from just 0.6% of the particles. This number is in good agreement with the experimentally observed incidence of so-called ‘hot particles’, which is regarded as less than 1%. Note, however, that a uniform population having sizes close to the optimum described above would have a much higher proportion of hot particles, and hence exhibit a substantial improvement in the Raman signal for a given amount of silver.

### Discussion of Theoretical Basis

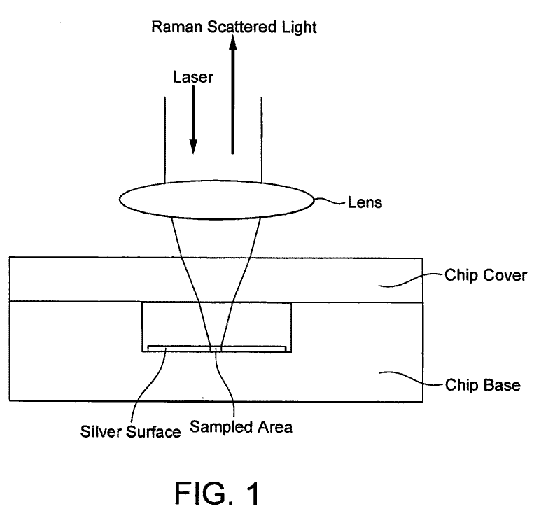

FIG. 1 shows a known microfluidic SER(R)S sensor. The illumination laser is focused onto a planar silver surface within a chamber on the microfluidic chip, thereby sampling a defined surface patch. Molecules adsorbed onto the surface in this region scatter photons according to the Raman mechanism, and a proportion of the scattered light passes back to the spectrometer, which records the spectrum. For surface enhanced resonance Raman spectroscopy (SERRS), the incident laser is selected to coincide with an absorbance peak of the Raman-scattering molecules, thereby enhancing the efficiency of generating the Raman signal. It is typical to use lasers of wavelength 532 nm since these are cheap and readily available.

One of the key benefits conferred by a microfluidic system is a dramatic reduction in reaction times due to physically limiting the reaction within a volume whose dimensions are comparable to the diffusion path lengths of the molecules involved.

The ability of a molecule to diffuse through a liquid medium is described by its diffusion coefficient, D, which can be estimated using the Stokes-Einstein equation

$$D = \frac{kT}{6 π η R}$$

where k is Boltzmann's constant, and T is the absolute temperature. This model assumes that the molecule is a sphere of radius R freely diffusing in a continuum solvent, the molecular size is at least 5× the solvent size, and that the liquid has a low viscosity (η).

Although proteins are not perfect spheres, their apparent Stokes' radii can be determined experimentally. Typical examples are shown in the table below.

| | Mol. Wt. | Stokes' Radius |
|---|---|---|
| Protein | (kDa) | (nm) |
| Ribonuclease A | 13.7 | 1.64 |
| Lysozyme | 14.7 | 1.9 |
| Chymotrypsinogen | 25 | 2.4 |
| Insulin | 34.2 | 2.7 |
| Ovalbumin | 43 | 3.05 |
| Haemoglobin | 65 | 3.5 |
| Serum Albumin | 67 | 3.55 |
| Hexokinase | 102 | 4.3 |
| Aldolase | 158 | 4.81 |
| Catalase | 232 | 5.22 |
| Ferritin | 440 | 6.1 |

These data can be used to derive an empirical method for predicting the Stokes' radius of a protein from its molecular weight.

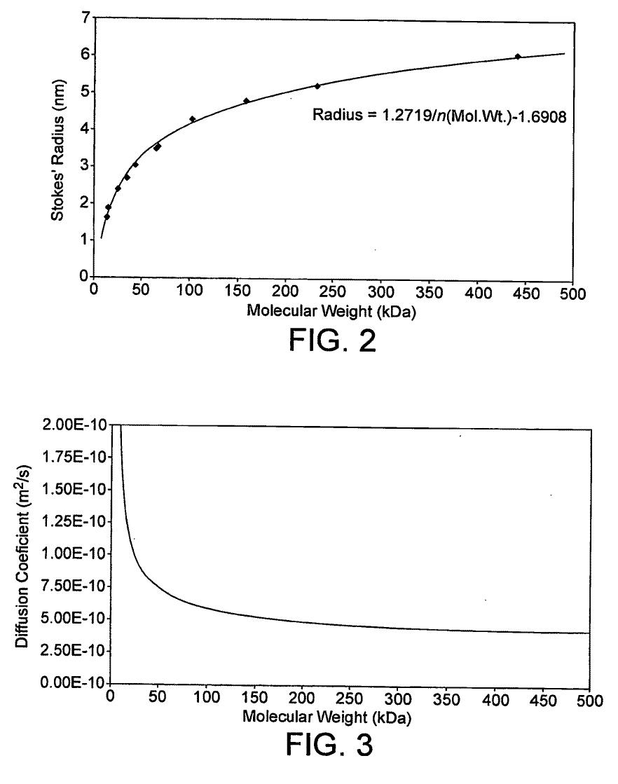

FIG. 2 shows a plot of the Stokes' radius plotted against molecular weight. The experimentally determined points lie on a logarithmic curve which follows the relationship R=1.2719 ln(Mol. Wt.)−1.6908. Using this equation, the predicted values for R can be used in the Stokes-Einstein equation to estimate the diffusion coefficient for any protein based solely on its molecular weight. A plot showing the calculated diffusion coefficient plotted against molecular weight can be seen in FIG. 3.

A common method for estimating the typical diffusion-limited timescale (t_{D}) in microfluidic systems is to use the equation:

$${t}_{D} = \frac{{l}^{2}}{2 D}$$

where I is the characteristic length of the system. For a typical protein of mass 100 kDa in a macro-scale system with I=1 cm, t_{D} is about 230 hours. For the same protein in a microfluidic system with I=100 μm, t_{D} is about 84 seconds.

The ‘typical timescale’ calculation shows that a microfluidic biosensor can confer an enormous benefit in assay time, provided the sensing reactions are carried out in a reaction chamber with dimensions comparable to the diffusion paths of the molecular components. However, this calculation does not take into account the depletion of the molecular components which accompanies the binding events at the surface of a molecular sensor. A more realistic model for a biosensor can be obtained using Fick's 1^{st} law of diffusion for the particle flux j due to a concentration gradient:

$$j = - D \frac{\partial c}{\partial x}$$

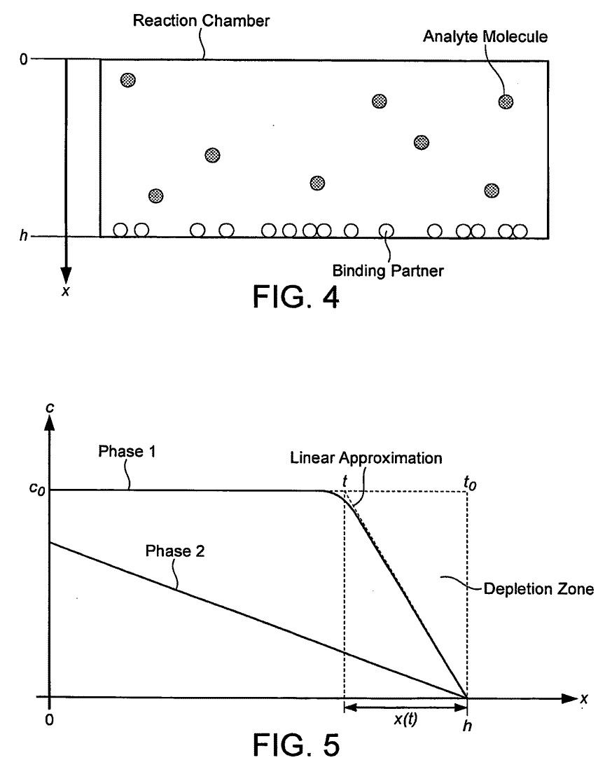

FIG. 4 shows a diagram of a biosensor model in which it is assumed that the analyte molecules are diffusing in a liquid according to the Stokes-Einstein model, that they are confined within a reaction chamber of height h, and that their selective agent (also known as binding partner such as antibodies or nucleic acid oligomers) are attached to one wall. It is also assumed that lateral diffusion is not important since as many molecules enter a defined region from the left as leave on the right (an assumption which strictly only holds for regions well away from the chamber side-walls). To simplify the calculation, it is assumed that binding to the selective agent is irreversible, that there is an excess of binding partners, and that each individual binding event is instantaneous.

The concentration of the analyte at height x and time t is defined as c(x,t). The initial state (t=0) has c(x,t)=c₀ (the initial concentration), and the depletion at the binding wall, where x=h, is c(h,t)=0. As it proceeds, the binding reaction reduces the concentration of the analyte close to the binding wall. This induces a diffusional flux of the analyte molecules towards this wall, since a concentration gradient has been formed, and over time the chamber becomes depleted of analyte molecules.

The calculation is performed in two phases shown graphically in FIG. 5. In phase 1 there is a depletion zone close to the wall at x=h, which is continually replenished by the diffusion of molecules from the rest of the chamber. In phase 2 this depletion zone has grown to include the entire chamber. One further approximation used in the calculation is to assume that the concentration gradients have linear profiles.

The first step is to calculate the time taken for phase 1. From Fick's law, diffusion to the binding wall is driven by the diffusion gradient over the depletion zone, which we've assumed has a linear profile:

$$j = - D \frac{\partial c}{\partial x} \approx - D \frac{{c}_{0}}{x ( t )}$$

The number of free analyte molecules, n, at time t in the chamber is given by:

$$n ( t ) = {hc}_{0} - \frac{1}{2} x ( t ) {c}_{0}$$

The rate of change (i.e. the flux) is then

$$\frac{d n}{d t} = - \frac{1}{2} \frac{d x ( t )}{d t} {c}_{0} = j = - D \frac{{c}_{0}}{x ( t )}$$

Using the boundary condition that x(0)=0, this leads to

x(t)=\sqrt{4Dt}

At the end of phase 1, occurring at time t₁, x(t₁)=h, so

$${t}_{1} = \frac{{h}^{2}}{4 D}$$

The calculation for phase 2 is similar. Again, we consider the diffusion to the binding wall, but this time we need only consider the depletion zone:

$$j = - D \frac{c ( 0 , t )}{h}$$

The number of free analyte molecules is then given by

$$n ( t ) = \frac{1}{2} hc ( 0 , t )$$

and so the flux is

$$\frac{d n}{d t} = - \frac{1}{2} h \frac{d c ( 0 , t )}{d t} = j = - D \frac{c ( 0 , t )}{h )}$$

Using the boundary condition that c(0,0)=c₀, we get

$$c ( 0 , t ) = {c}_{0} {e}^{( \frac{2 D}{{h}^{3}} t )}$$

Since this is an exponential decay, it would take an infinite time for the concentration of analyte to reach zero. However, we can calculate the time taken for a proportion p of the analyte to bind (0<p<1). We'll call this t₂.

$$\frac{1}{2} c ( 0 , {t}_{2} ) h = ( 1 - p ) {c}_{0} h$$

so

c(0,t₂)=2(1−p)c₀

using the exponential decay equation for phase 2, it can be seen that

$${t}_{2} = \frac{- ln ( 2 ( 1 - p ) ) {h}^{2}}{2 D}$$

The time taken for the proportion p of the analyte molecules to bind, tₚ, is then given by

$${t}_{p} = {t}_{1} + {t}_{2} = \frac{{h}^{2}}{4 D} - \frac{ln ( 2 ( 1 - p ) ) {h}^{2}}{2 D}$$

$$or$$

$${t}_{p} = \frac{{h}^{2}}{2 D} ( \frac{1}{2} - ln ( 2 ( 1 - p ) ) )$$

Comparing this equation with the accepted ‘typical timescale’ equation for microfluidic systems:

$${t}_{D} = \frac{{l}^{2}}{2 D}$$

It is clear that chamber height h takes the place of the characteristic length l, and there is an additional term describing an exponential decay introduced into the system due to the analyte depletion.

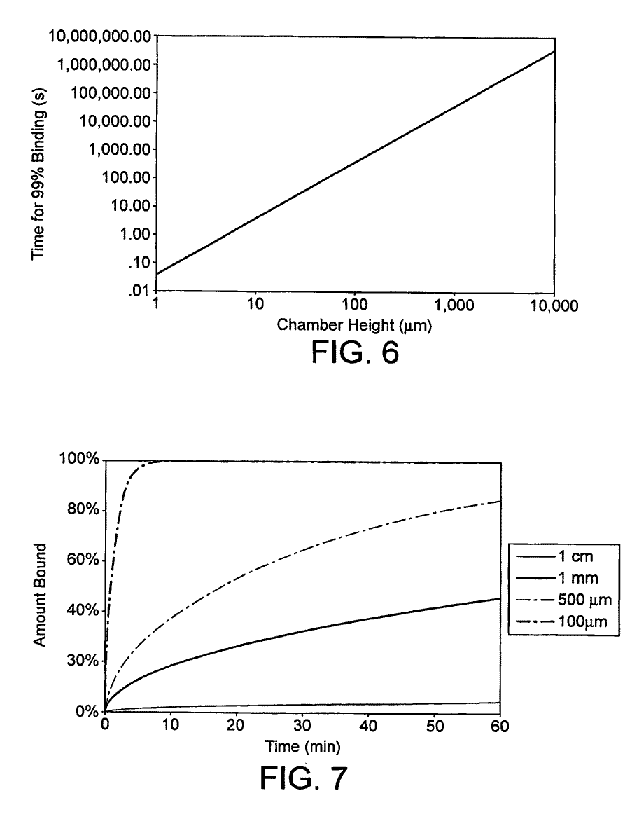

For a typical 100 kDa protein, the time taken to achieve 99% maximal binding for microfluidic reaction chambers of different heights can be calculated and a plot of chamber height against time for 99% binding to occur is shown in FIG. 6.

The plot of FIG. 6 uses a log-log scale since the numerical ranges for both axes cover several orders of magnitude. For chamber heights below around 40 μm, binding is complete in seconds. For heights between 40 and 310 μm, 99% binding is achieved in minutes, and for heights beyond 310 μm binding requires hours. A typical microtitre plate has length scales of a few millimetres, corresponding to binding times upwards of 10 hours, although this assumes that the plate is not shaken or stirred during the binding, which would speed up the process considerably.

A calculated binding time course over 1 hour for the typical 100 kDa protein example is shown in FIG. 7 for different chamber heights. The benefits of reducing the length scales are apparent—for a ‘macro scale’ of 1 cm height less than 5% binding is achieved after an hour, whereas binding is essentially complete after around 6 minutes with a 100 μm chamber height.

1-47. (canceled)

48. A reaction carrier into which a sample for testing can be introduced for use in a detector arrangement for detecting the presence, absence or quantity of an analyte in a sample based on an optical response to illumination of a dye, the reaction carrier comprising:
a solid support material arranged to define a volume, the support material being porous to the dye; and
metal particles distributed and immobilized within the volume and supported by the support material, and
wherein the average spacing of the metal particles within the support material is a multiple of half the wavelength of the illumination, the solid support material and metal particles acting as a metamaterial, with properties differing from those of its constituent parts, so as to enhance an optical response to illumination of the dye.

49. A reaction carrier according to claim 48, wherein the type of the metal of the metal particles, the geometry of the metal particles and the distribution of the metal particles are arranged to enhance the response to illumination by an interaction between the electrons in the metal particles and the dye.

50. A reaction carrier according to claim 48, wherein the response detected is a SERS interaction and/or a SERRS interaction.

51. A reaction carrier according to claim 48, wherein the solid support material is arranged to have the dye distributed within the volume and the response to illumination is enhanced as a result of the dye being distributed within the volume and proximate to the metal particles that are also distributed within the volume.

52. A reaction carrier according to claim 48, wherein the solid support material is comprised of one or more substrate particles and the metal particles are deposited on the external surface of the one or more substrate particles.

53. A reaction carrier according to claim 52, wherein the metal particles are deposited within the one or more substrate particles.

54. A reaction carrier according claim 48, wherein the metal of the metal particles is silver, gold or copper.

55. A reaction carrier according to claim 48, wherein the metal particles have dimensions of the order of the mean free path of electrons in the metal of the metal particles.

56. A reaction carrier according to claim 48, wherein the metal particles have a triangular geometry.

57. A reaction carrier according to claim 48, wherein the dye is attached within the volume to a selective agent capable of binding the analyte such when the analyte binds to the selective agent the dye moves to a region near the metal particles.

58. A detector arrangement according to claim 57, wherein the dye is displaceably attached to and held away from the metal particles by the selective agent.

59. A reaction carrier according to claim 53, wherein the substrate particles are porous to the dye.

60. A reaction carrier according to claim 53, wherein the substrate particles are porous to the dye but not other materials in the analyte sample.

61. A reaction carrier according to claim 53, wherein the distance between neighboring particles of the metal particles is of the order of the mean free path of the dye.

62. A reaction carrier according to claim 48, wherein the support material does not produce a response to illumination within the frequency range of the response to illumination of the dye.

63. A reaction carrier according to claim 48, wherein an analyte to be detected functions as the dye.

64. A reaction carrier according to claim 48, wherein the support material is comprised of silica.

65. A reaction carrier according to claim 48, wherein the support material is comprised of CPG.

66. A reaction carrier according to claim 48, wherein the response to illumination is a change in intensity at a given wavelength shift due to Raman scattering.

67. A reaction carrier according to claim 48, wherein the dimensions of the metal particles are of the order of 10-250 nm.

68. A reaction carrier according to claim 48, wherein the dimensions of the metal particles and the wavelength of illumination are such that a significant proportion of the incident radiation is absorbed by the metal particles.

69. A reaction carrier according to claim 48, wherein the spatial dispersion of the metal particles and the wavelength of illumination are such that a significant proportion of the incident radiation is absorbed by the metal particles.

70. A reaction carrier according to claim 48, wherein the spatial dispersion of the metal particles is approximately equal to half the wavelength of the illumination within the volume.

71. A detector arrangement comprising:
an illumination source;
a detector;
a dye;
a reaction carrier into which a sample for testing can be introduced for use in a detector arrangement for detecting the presence, absence or quantity of an analyte in a sample based on an optical response to illumination of the dye, the reaction carrier including:
a solid support material arranged to define a volume, the support material being porous to the dye; and
metal particles distributed and immobilized within the volume and supported by the support material, and
wherein the average spacing of the metal particles within the support material is a multiple of half the wavelength of the illumination, the solid support material and metal particles acting as a metamaterial, with properties differing from those of its constituent parts, so as to enhance an optical response to illumination of the dye, and
wherein the illumination source illuminates the reaction carrier with a specified wavelength of radiation to detect the absence, presence or quantity of dye responsive to illumination to indicate the absence, presence or quantity of an analyte.

72. A detector arrangement according to claim 71, wherein the illumination source is arranged to provide illumination that covers at least a portion of the volume defined by the support material.

73. A detector arrangement according to claim 72, wherein the illumination source is focused such that the portion of the volume comprises the beam of the illumination source.

74. A detector arrangement according to claim 73, wherein the portion of the volume comprises the beam of the illumination source both sides of a focal point of the illumination source.

75. A method of detecting the presence, absence or quantity of an analyte in a sample in a reaction carrier comprising:
providing within a reaction carrier a solid support material arranged to define a volume and metal particles distributed and immobilized within the volume and supported by the support material, the support material being porous to a dye, the solid support material and metal particles acting as a metamaterial, with properties differing from those of its constituent parts, so as to enhance an optical response to illumination of a dye;
providing the dye;
illuminating the reaction carrier with a specified wavelength of radiation; and
detecting the response to illumination from the dye to determine the quantity of dye to indicate the presence, absence or quantity of an analyte, wherein the average spacing of the metal particles within the support material is a multiple of half the wavelength of the illumination radiation.

76. A method according to claim 75, wherein the dye is attached to a selective agent capable of binding the analyte, such that, on introduction of the sample, the analyte may bind to the selective agent causing the dye to move to a region near the metal particles.

77. A method according to claim 76, wherein the selective agent holds the dye away from the metal particles until introduction of the sample to the volume which causes the dye to detach and move to a region near the metal particles.

78. A method according to claim 75, wherein, on introduction of the sample, the analyte may bind to the selective agent causing the dye to detach and diffuse into the support material thereby moving to a region near the metal particles.

79. A method according to claim 78, wherein the support material is comprised of a one or more substrate particles and the metal particles are deposited within the one or more substrate particles, and wherein, on introduction of the sample, the analyte may bind to the selective agent causing the dye to detach and diffuse into the one or more particles thereby moving to a region near the metal particles.

80. A method according to claim 75, wherein the support material is porous to the dye but not other materials so that when the analyte displaces the dye only the dye may diffuse into the support material.

81. A method according to claim 79, wherein the support material is porous to the sample, but the one or more substrate particles are not porous to the analyte, whereby, when the analyte displaces the dye, only the dye may diffuse into the one or more substrate particles.

82. A method according to claim 75, comprising introducing the analyte sample to the reaction carrier causing the dye to enter the volume.

83. A method according to claim 75, comprising introducing the analyte sample to the volume.

84. A method according to claim 75, comprising illuminating at least a portion of the volume defined by the support material with the illumination source.

85. A method according to claim 84, wherein the illumination source is a laser and further comprising arranging the laser such that the portion of the volume comprises the beam of the laser.

86. A method according to claim 85, wherein the portion of the volume comprises the beam of the laser both sides of a focal point of the laser.

87. A method according to claim 75, wherein the dye is attached to a selective agent capable of binding the analyte and held in a region near the metal particles, such that, on introduction of the analyte sample, the analyte may bind to the selective agent causing the dye to move away from the region near the metal particles.

88. A method according to claim 87, wherein the selective agent holds the dye in a region near the metal particles until introduction of analyte which causes the dye to detach and move away from the region near the metal particles.

89. A reaction carrier according to claim 48, wherein the dye is attached within the volume to a selective agent capable of binding the analyte and held in a region near the metal particles, such when the analyte binds to the selective agent the dye moves away from the region near the metal particles.

90. A reaction carrier according to claim 89, wherein the dye is displaceably attached to and held in the region near the metal particles by the selective agent.

91. A reaction carrier according to claim 89, wherein the substrate particles comprise a plurality of voids within which the metal particles may be deposited, the dimensions of the voids being less than the wavelength of the illumination source.

92. A reaction carrier according to claim 91, wherein the void dimensions are approximately 200-500 nm.
